(19) United States
(12) Patent Application Publication
(10) Pub. No.: US 2023/0409665 A1
(43) Pub. Date: Dec. 21, 2023

(54) SYSTEMS AND METHODS OF APPLYING TENSOR RADIAL BASIS FUNCTION NETWORKS TO MACHINE LEARNING

(71) Applicant: Multiverse Computing SL, San Sebastián (ES)

(72) Inventors: Samuel Palmer, Toronto (CA); Raj Patel, Toronto (CA); Román Orús, San Sebastián (ES); Saeed Jahromi, San Sebastián (ES); Chia-Wei Hsing, San Sebastián (ES); Serkan Sahin, Munich (DE)

(73) Assignee: Multiverse Computing SL, San Sebastián (ES)

(21) Appl. No.: 17/857,491

(22) Filed: Jul. 5, 2022

(30) Foreign Application Priority Data
Jun. 15, 2022 (EP) 22382572.0

(51) Int. Cl. G06F 17/13; G06F 17/16

(52) U.S. Cl. CPC G06F 17/13; G06F 17/16

(57) ABSTRACT

A method of embedding ordinary differential equations (ODEs) into tensor radial basis networks is presented herein. The method involves receiving a tensored basis function having D dimensions and zeroth-, first-, and second-derivative coefficients A_d, B_d, and C_d; defining A_hat, B_hat, and C_hat as a function of A, B, and D, and C_hat as function of A, C, and D, respectively; defining an orthogonal exotic algebra a, b, c; applying a, b, and c, along with A_hat, B_hat, and C_hat, as coefficients for the zeroth-derivative, first-derivative, and second-derivative terms; and embedding the updated tensored basis function by forming a matrix product state (MPS). The MPS can be trained by initializing MPS 3-tensors with random coefficients and sweeping left and right along the MPS and updating the MPS 3-tensors.

### FIELD

Various embodiments are described herein that generally relate to a system for applying tensor radial basis function networks to machine learning, as well as the methods.

### BACKGROUND

The following paragraphs are provided by way of background to the present disclosure. They are not, however, an admission that anything discussed therein is prior art or part of the knowledge of persons skilled in the art.

Solving ordinary differential equations (ODEs) on high-dimensional meshes has applications to a variety of technical problems. Conventional methods of solving such ODEs typically require large amounts of memory and require large computation times.

There is a need for a system and method that addresses the challenges and/or shortcomings described above.

### SUMMARY OF VARIOUS EMBODIMENTS

Various embodiments of a system and method for applying tensor radial basis function networks to machine learning, and computer products for use therewith, are provided according to the teachings herein.

According to one aspect of the invention, there is disclosed a system for embedding ordinary differential equations into tensor radial basis networks. The system comprises at least one processor configured to: receive a tensored basis function having D dimensions and coefficients A_d, B_d, and C_d, where A_d is a zeroth-derivative coefficient for zeroth-derivative terms, B_d is a first-derivative coefficient for first-derivative terms, and C_d is a second-derivative coefficient for second-derivative terms: define A_hat as a function of A and D, B_hat as a function of A, B, and D, and C_hat as function of A, C, and D; define an orthogonal exotic algebra a, b, c; apply a, b, and c, along with A_hat, B_hat, and C_hat, as coefficients for the zeroth-derivative, first-derivative, and second-derivative terms, respectively, thereby generating an updated tensored basis function; and embed the updated tensored basis function by forming a matrix product state (MPS) and training the MPS.

In at least one embodiment, the MPS comprises MPS 3-tensors, and training the MPS comprises: initializing the MPS 3-tensors with random coefficients; sweeping left along the MPS and updating the MPS 3-tensors; and sweeping right along the MPS and updating the MPS 3-tensors.

In at least one embodiment, the at least one processor is configured to embed the tensored basis function as a matrix of scalar coefficients.

In at least one embodiment, the at least one processor is configured to embed the tensored basis function as products of A_hat, B_hat C_hat, corresponding a, b, c, coefficients, and corresponding tensored basis function derivative terms.

In at least one embodiment, the exotic orthogonal algebra has a*a=1, a*b=1, a*c=1, b*b=0, cc=0, and b*c=0.

In at least one embodiment, updating the MPS 3-tensors comprises updating the MPS 3-tensors with gradient descent rules.

In at least one embodiment, the MPS is further trained by: contracting each 3-tensor coefficient with a corresponding leg 1-tensor.

In at least one embodiment, the MPS is further trained by: contracting pairs of adjacent 3-tensors.

In at least one embodiment, updating the MPS 3-tensors comprises updating the MPS 3-tensors pairwise.

In at least one embodiment, the MPS is trained until a convergence criterion is satisfied.

According to another aspect of the invention, there is disclosed a method of embedding ordinary differential equations (ODEs) into tensor radial basis networks. The method comprises: receiving a tensored basis function having D dimensions and coefficients A_d, B_d, and C_d, where A_d is a zeroth-derivative coefficient for zeroth-derivative terms, B_d is a first-derivative coefficient for first-derivative terms, and C_d is a second-derivative coefficient for second-derivative terms; defining A_hat as a function of A and D, B_hat as a function of A, B, and D, and C_hat as function of A, C, and D; defining an exotic orthogonal algebra a, b, c; applying a, b, and c, along with A_hat. B_hat, and C_hat, as coefficients for the zeroth-derivative, first-derivative, and second-derivative terms, respectively, thereby generating an updated tensored basis function; and embedding the updated tensored basis function by forming a matrix product state (MPS) and training the MPS.

In at least one embodiment, the MPS comprises MPS 3-tensors, and training the MPS comprises: initializing the MPS 3-tensors with random coefficients; sweeping left along the MPS and updating the MPS 3-tensors: and sweeping right along the MPS and updating the MPS 3-tensors.

In at least one embodiment, the tensored basis function is embedded as a matrix of scalar coefficients.

In at least one embodiment, the tensor basis function is embedded as products of A_hat, B_hat C_hat, corresponding a, b, c, coefficients, and corresponding tensored basis function derivative terms.

In at least one embodiment, the exotic orthogonal algebra a, b, c, has rules a*a=1, a*b=1, a*c=1, b*b=0, c*c=0, and b*c=0.

In at least one embodiment, updating the MPS 3-tensors comprises updating the MPS 3-tensors with gradient descent rules.

In at least one embodiment, the MPS is further trained by: contracting each 3-tensor coefficient with a corresponding leg 1-tensor.

In at least one embodiment, the MPS is further trained by: contracting pairs of adjacent 3-tensors.

In at least one embodiment, updating the MPS 3-tensors comprises updating the MPS 3-tensors pairwise.

In at least one embodiment, the MPS is trained until a convergence criterion is satisfied.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a block diagram of an example embodiment of a system for applying tensor radial basis function networks to machine learning.

FIG. 2 shows a diagram of an example mesh of centered radial basis functions.

FIG. 3 shows a diagram of another example mesh of centered radial basis functions.

FIG. 4 shows a diagram of an example of a tensor contraction.

FIG. 5 shows an example tensor diagram.

FIG. 6 shows an example of coefficients used in the formation of a matrix product state system for embedding an ODE.

FIG. 7 shows an example of the formation of a matrix product state system for embedding an ODE.

FIG. 8 shows an example of the formation of a matrix product state system for embedding an ODE in matrix form.

FIG. 9 shows a flowchart of an example method for applying tensor radial basis function networks to machine learning.

FIG. 10 shows a flowchart of an example method of training a matrix product state when applying tensor radial basis function networks to machine learning.

FIG. 11 shows a tensor diagram of an example method of training an MPS using a density matrix renormalization group (DMRG) algorithm.

FIG. 12 is a detailed diagram of the tensor diagram shown in FIG. 11.

FIG. 13 shows an example tensor diagram with parallel computation blocks.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” in conjunction with describing the operation of any system or method described herein is meant to be understood as describing a user interface for performing initialization, configuration, or other user operations.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object-oriented programming. The program code may be written in C⁺⁺, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

In accordance with the teachings herein, there are provided various embodiments of systems and methods for applying tensor radial basis function networks to machine learning, and computer products for use therewith.

At least some of the embodiments described herein may have applications in an electrical grid, an electricity network (e.g., of a building, of a street, of a neighborhood, etc.), a portfolio of financial assets or derivatives, a stock market, a system of devices and/or machines (e.g., of a factory, of an industrial installation, etc.), or a set of patients of a hospital unit (e.g., intensive care unit, non-intensive care unit, etc.).

By way of example, in the case of an electrical grid or electricity network, the systems and methods described herein may provide data for optimization of the energy markets offered, or for predictive maintenance of the different devices of the grid/network. In a stock market application, the systems and methods described herein may predict the evolution of the stock market, and in a portfolio of financial assets or derivatives, the systems and methods described herein may optimize portfolios or provide data for pricing or deep hedging. When the embodiments described herein are used in devices and/or machines, the systems and methods described herein may determine whether the system is functioning correctly, and/or whether predictive maintenance needs to be conducted because a device/machine might stop working and, where patients are concerned, the system may predict the evolution of the patients.

For instance, the set of data used may be measurements from a plurality of measurements of the devices and/or machines of the system that measured the behavior thereof, or measurements of the patients (with, e.g., biosensors). The systems and methods described herein may then provide, for instance, a condition or characteristic of the system indicative of whether a device or machine is expected to malfunction, or indicative of whether a patient is expected to have a seizure or crisis.

### 1. Overview

Machine learning can require large amounts of memory and processing time depending on the techniques used. One such technique that can be memory-intensive is solving high dimensional ordinary differential equations (ODE) using radial basis function networks. A machine learning system may improve its use of computational resources using various techniques or optimizations.

To reduce the amount of memory to solve ODEs using radial basis function networks, a machine learning system can tensorize radial basis functions into a matrix product state (MPS) tensor network, known as a tensor radial basis function network (TRBFN). This allows for an exponentially large number of radial basis functions to be efficiently computed with polynomial (e.g., linear) memory overheads.

To further achieve memory savings, a machine learning system can introduce a scheme to embed the ODE directly into the MPS. For example, the machine learning system may derive a new set of ODE coefficients that preserve the original ODE. Also, the machine learning system may derive a novel exotic algebra used to efficiently eliminate unwanted mixed derivative terms during tensorization.

The advantages of the embodiments of the invention described herein can be achieved, for example, because the machine learning system can train the new TRBFN to solve a given ODE using existing MPS training algorithms. In addition, for example, the machine learning system can exploit the structure of the MPS training algorithm to obtain parallelism when solving high-dimensional problems using the TRBFN.

### Basic Definitions

Tensor A multidimensional array of complex numbers.

Bond dimension: Size of the dimensions of the tensors which is categorized into two families: (a) virtual dimension which controls the correlation between data; and (b) physical dimension which is the size of the input and output of neurons in each neural network (NN) layer.

Matrix product state (MPS): Tensor (e.g., a rank-3 tensor) widely used in algorithms for finding the ground state of a physical system, such as a Density Matrix Renormalization Group (DMRG).

Matrix product operator (MPO): Tensor (e.g., a rank-4 tensor) with (two) physical dimensions and (two) virtual dimensions which are used as a replacement for weights in a NN.

Tensor network diagram: Graphical notation in which each tensor is replaced by an object (e.g., circle, square) and its dimensions are denoted by links (e.g., legs) connected to the object.

Tensor contraction: Multiplication of tensors along their shared dimension (e.g., summation over shared indices of the tensors).

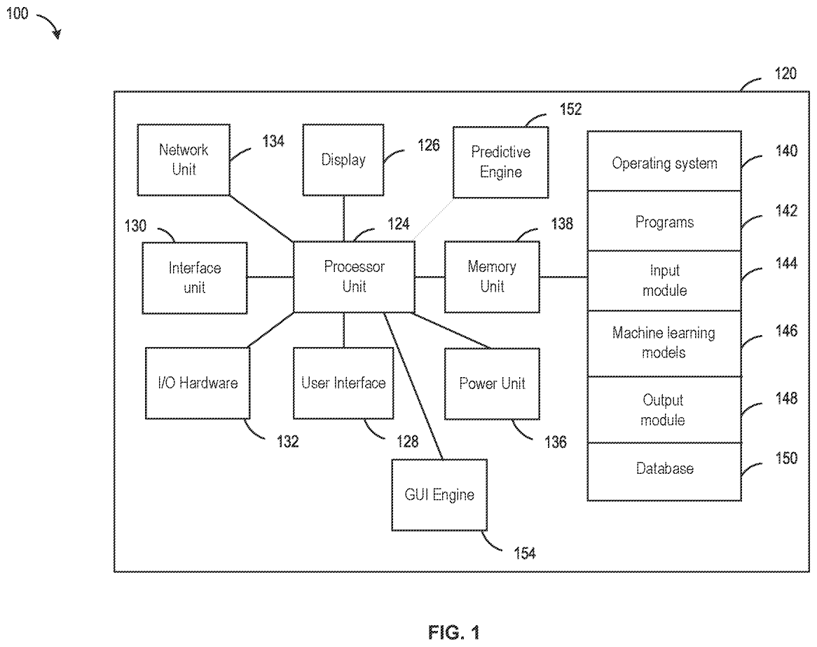

Reference is first made to FIG. 1, showing block diagram of an example embodiment of a system 100 for applying tensor radial basis function networks to machine learning. The system 100 includes at least one server 120. The server 120 may communicate with one or more user devices (not shown), for example, wirelessly or over the Internet. The system 100 may also be referred to as a machine learning system when used as such.

The user device may be a computing device that is operated by a user. The user device may be, for example, a smartphone, a smartwatch, a tablet computer, a laptop, a virtual reality (VR) device, or an augmented reality (AR) device. The user device may also be, for example, a combination of computing devices that operate together, such as a smartphone and a sensor. The user device may also be, for example, a device that is otherwise operated by a user, such as a drone, a robot, or remote-controlled device; in such a case, the user device may be operated, for example, by a user through a personal computing device (such as a smartphone). The user device may be configured to run an application (e.g., a mobile app) that communicates with other parts of the system 100, such as the server 120.

The server 120 may run on a single computer, including a processor unit 124, a display 126, a user interface 128, an interface unit 130, input/output (I/O) hardware 132, a network unit 134, a power unit 136, and a memory unit (also referred to as “data store”) 138. In other embodiments, the server 120 may have more or less components but generally function in a similar manner. For example, the server 120 may be implemented using more than one computing device.

The processor unit 124 may include a standard processor, such as the Intel Xeon processor, for example. Alternatively, there may be a plurality of processors that are used by the processor unit 124, and these processors may function in parallel and perform certain functions. The display 126 may be, but not limited to, a computer monitor or an LCD display such as that for a tablet device. The user interface 128 may be an Application Programming Interface (API) or a web-based application that is accessible via the network unit 134. The network unit 134 may be a standard network adapter such as an Ethernet or 802.11x adapter.

The processor unit 124 may execute a predictive engine 152 that functions to provide predictions by using machine learning models 146 stored in the memory unit 138. The predictive engine 152 may build a predictive algorithm through machine learning. The training data may include, for example, image data, video data, audio data, and text.

The processor unit 124 can also execute a graphical user interface (GUI) engine 154 that is used to generate various GUIs. The GUI engine 154 provides data according to a certain layout for each user interface and also receives data input or control inputs from a user. The GUI then uses the inputs from the user to change the data that is shown on the current user interface, or changes the operation of the server 120 which may include showing a different user interface.

The memory unit 138 may store the program instructions for an operating system 140, program code 142 for other applications, an input module 144, a plurality of machine learning models 146, an output module 148, and a database 150. The machine learning models 146 may include, but are not limited to, image recognition and categorization algorithms based on deep learning models and other approaches. The database 150 may be, for example, a local database, an external database, a database on the cloud, multiple databases, or a combination thereof.

In at least one embodiment, the machine learning models 146 include a combination of convolutional and recurrent neural networks. Convolutional neural networks (CNNs) are designed to recognize images, patterns. CNNs perform convolution operations, which, for example, can be used to classify regions of an image, and see the edges of an object recognized in the image regions. Recurrent neural networks (RNNs) can be used to recognize sequences, such as text, speech, and temporal evolution, and therefore RNNs can be applied to a sequence of data to predict what will occur next. Accordingly, a CNN may be used to read what is happening on a given image at a given time, while an RNN can be used to provide an informational message.

The programs 142 comprise program code that, when executed, configures the processor unit 124 to operate in a particular manner to implement various functions and tools for the system 100.

### 2. Introduction to ODEs

Consider a general linear second order ODE of the form

$$[ {\sum }_{d} {C}_{d} \frac{{\partial }^{2}}{\partial {x}_{d}^{2}} + {\sum }_{d} {B}_{d} \frac{\partial }{\partial {x}_{d}} + {A}_{d} ] u ( x ) = f ( x ) \qquad ( 1 )$$

A more succinct version of formula (1) may be represented as

$$ℒ [ u ( x ) ] - f ( x ) = 0 \qquad ( 2 )$$

$$where ℒ [ ] = {\sum }_{d} {C}_{d} \frac{{\partial }^{2}}{\partial {x}_{d}^{2}} + {\sum }_{d} {B}_{d} \frac{\partial }{\partial {x}_{d}} + {A}_{d} \qquad ( 3 )$$

For simplicity, one may assume for now on that C_{d}=C∀C_{d} and B_{d}=C=B∀B_{d}, but the methods presented herein may be extended to the more general case. For example, the method(s) presented herein may be applied to higher order derivatives, higher dimensional systems, and/or crossed partial derivatives.

### 2.1 Radial Basis Functions

One numerical method for solving differential equations is using radial basis functions. An outline of the radial basis function solution method is given below.

This method is a type of collocation or meshless method, where samples x∈Ω may be randomly sampled.

Radial basis function networks (RBFNs) are the simplest neural network and usually consist of only one layer and a set of linear output weights. In other words, they are linear combinations of radial basis functions (RBFs).

An RBF is a function where the value of a point x is calculated as a function of its distance from a center c and a width parameter σ. The most common is a Gaussian RBF

$${ϕ}_{i} ( ‖ x - {c}_{i} ‖ , {σ}_{i} ) = exp ( - \frac{{‖ x - {c}_{i} ‖}^{2}}{2 {σ}_{i}^{2}} ) \qquad ( 4 )$$

To use RBFs for function approximation, take a set of N RBFs, {ϕ(c₀), . . . , ϕ(cₙ)} with different centers in the domain cₙ∈Ω.

The function approximation, û(x) is given by

$$\hat{u} ( x ) = {\sum }_{i} {w}_{i} {ϕ}_{i} ( ‖ x - {c}_{i} ‖ , {σ}_{i} ) \qquad ( 5 )$$

in matrix form as

û(x)=Φw (6)

where Φ is called the design matrix; each row corresponds to a collocation point x∈Ω, and the columns correspond to each centered RBF in the set {ϕ(c₀), . . . , ϕ(cₙ)}.

When applying this method for solving ODEs, apply the operator [symbol] to each entry in the design matrix

[symbol]

[Φ]w=f(x) (7)

To solve this, find the RBF weight vector w. This over-determined system can be solved by linear regression.

This is also a generalization of kernel methods. An SVM is an RBFN with centers located at each sample cᵢ=x∈Ω.

Although these methods have recently fallen out of popularity for more cutting-edge machine learning methods, the fundamental ideas are the same—to approximate a solution of an ODE using a function approximator.

One of the main reasons in the decline of RBF popularity is that they suffer from the curse of dimensionality; as the dimensions of the ODE increase, the number of RBFs required to obtain a good solution increases exponentially. Using methods from tensor networks, a machine learning system can efficiently handle an exponentially large number of RBFs for high-dimensional problems.

### 3. Tensorized Radial Basis Functions

The methodology used by the system 100 is based on solving second order ODEs using tensorized radial basis function networks. This aims to solve two major problems that arise when using traditional RBF methods.

The first problem is to extend to high dimensions where RBF mesh sizes become intractable. For example, even a coarse discretization of each spatial dimension leads to an exponentially large mesh. Suppose D=10 and N_{D}=10, then:

mesh size=10¹⁰ (8)

The second problem is to enhance algorithmic parallelism. Traditional RBFs rely on using regression solvers; typically, such numerical algorithms are hard to efficiently parallelize.

### 3.1 Tensor Basis Functions

The method used by system 100 relies upon the condition that the basis function, ϕ, considered for tensorization is multiplicitly separable. Consider a D-dimensional vector space xₘ=[xₒ^{m}, . . . , x_{D}^{m}], then

$$ϕ ( x , c ) = {\prod }_{n} β ( {x}_{n} , {c}_{n} ) \qquad ( 9 )$$

Using product decomposition, one can take the tensor product of vectors of basis functions in each dimension creating an RBF mesh \hat{Φ},

$$\hat{Φ} = {{⊗}_{d}}^{D} {ϕ}_{d} \qquad ( 10 )$$

This creates an exponentially large mesh of RBF centers from a linear number of basis functions in each dimension. RBF centers can be defined as an arbitrary product of points along each dimension.

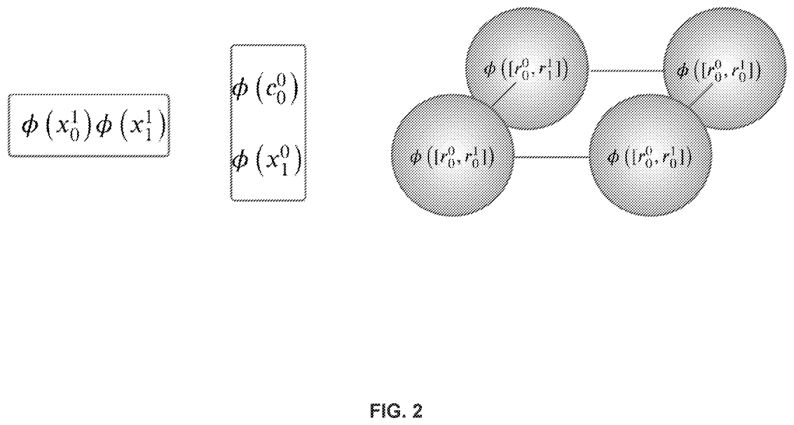

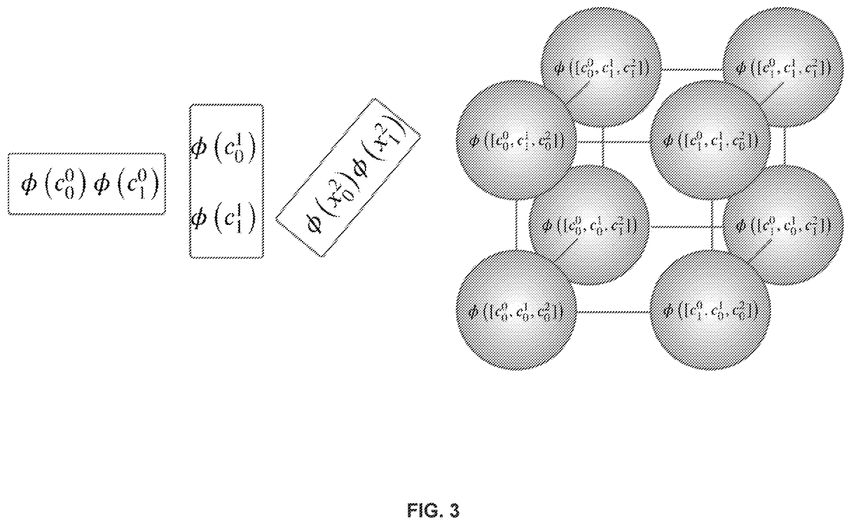

For example, consider a 2D system with 2 RBF centers in each dimension. This creates a mesh of centered RBFs as shown in FIG. 2. Now consider a 3D system with 2 RBF centers in each dimension. This creates a mesh of centered RBFs as shown in FIG. 3.

In this example, a set of partial basis functions is assigned to each dimension, where each partial basis function only has a center in the given dimension. Taking a product of these partial basis functions creates a complete basis function centered in the D-dimensional space. In this example, it can be seen that by storing 6 partial basis functions, it is possible to create 8 complete basis functions.

If one stores N partial basis functions in D dimensions, N×D partial basis functions, one can create N^{D} complete basis functions distributed within the domain Ω.

### 3.2 Gaussian Kernel

One realization of a radial basis function that can be easily tensorized is the Gaussian kernel equipped with a separable distance metric

$$ϕ = {e}^{- \frac{r}{{σ}^{2}}} \qquad ( 11 )$$

where r is the radial distance metric. The separable metric can then be used, which has the form

$$r = {\sum }_{d} {( {x}_{d} - {c}_{d} )}^{2} \qquad ( 12 )$$

### 4. Tensorized Radial Basis Networks

As has been shown above, a tensor product of a multiplicitly separable basis function allows the creation of an exponential number of centered basis functions. For notation, each partial basis function is indexed in the dth dimension by i_{d}∈{0 . . . N} where there are N partial basis functions in each dimension.

To form a regression, one requires a weighted sum over all combinations of one partial basis function from each dimension:

$${\sum }_{\{ {i}_{0} , … , {i}_{D} \}} {w}_{{i}_{0} , … , {i}_{D}} {\prod }_{n ∈ \{ {i}_{0} , … , {i}_{D} \}} {ϕ}_{n} \qquad ( 13 )$$

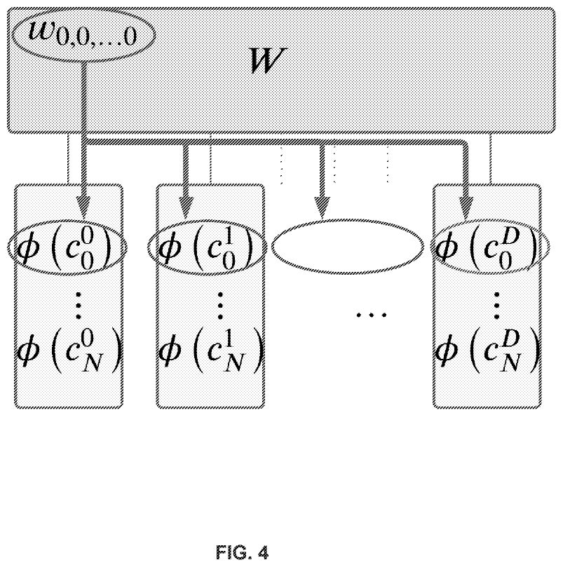

This is the exact form of a tensor contraction, and diagrammatically can be expressed as shown in FIG. 4, where the circled weight w_{0,0 . . . ,0} corresponds to the product of all the circled partial basis functions ϕ(c₀⁰), ϕ(c₀¹), . . . , ϕ(c₀^{D}).

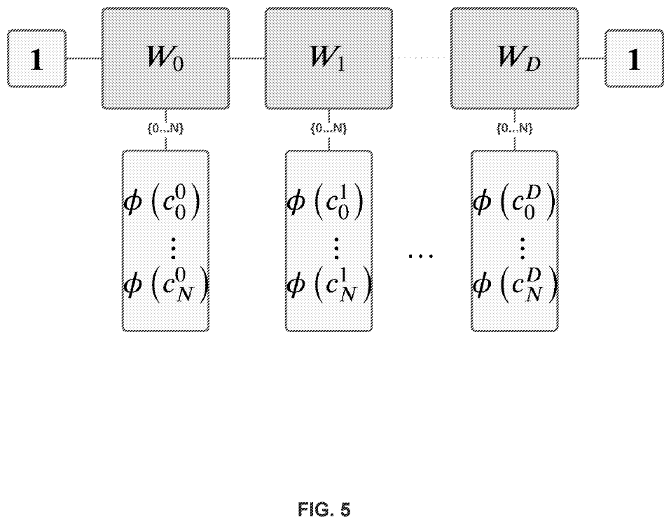

Decomposing W, one can form a tensor network known as a matrix product state (MPS). This can be expressed as a tensor diagram as shown in FIG. 5, where now the weight w_{0, . . . ,0} is a product of coefficients from the 3-tensors W₀, . . . , W_{D}.

In the tensor diagram shown in FIG. 4, W is a trainable weight tensor. The squares containing only the single digit ‘1’ represent vectors of 1s that turn everything into a scalar. Each column corresponds to the basis decomposed in its respective dimension. Each entry in the ϕ vectors represents the basis function centered at that point in the dimension.

The advantages of decomposing W→W₀, . . . , W_{D} have applications in physics, such as to allow for a large tensor W to be stored with linear memory overhead and to compute the full contraction of the MPS more efficiently.

5. Embedding ODEs into Tensor Radial Basis Networks

The previously described formulation as a matrix product state is useful for creating a regression of the tensored basis functions. However, this does not address the need for fitting the derivatives of a function in an ODE.

Consider the tensored basis function

$$Φ = {\prod }_{d} {ϕ}_{d} ( {x}_{d} ) \qquad ( 14 )$$

Given that for each d the RBFs are dimensionally independent, then by the chain rule, the derivatives of the tensored basis functions with respect to an element in dimension d can be given by

$$\frac{{\partial }^{n}}{\partial {x}_{d}^{n}} Φ = \frac{{\partial }^{n}}{\partial {x}_{d}^{n}} {ϕ}_{d} {\prod }_{\hat{d} \neq d} {ϕ}_{\hat{d}} \qquad ( 15 )$$

In Equation 15, n ranges from 1 to 2. However, in the case of higher orders, n can go to 3 or 4, for example.

To embed the ODE into the MPS RBF vector, this can be done by, for example, embedding the ODE as a vector of scalar coefficients or as a matrix.

Embedding the ODE as a vector of scalar coefficients may use:

$${ϕ}_{d} = ( \begin{matrix}\begin{matrix}A {ϕ}_{d , 0} + B {ϕ}_{d , 0}^{′} + C {ϕ}_{d , 0}^{″} \\ ⋮\end{matrix} \\ A {ϕ}_{d , N} + B {ϕ}_{d , N}^{′} + C {ϕ}_{d , N}^{″}\end{matrix} ) \qquad ( 16 )$$

Embedding the ODE as a matrix may use:

$${ϕ}_{d} = ( \begin{matrix}A {ϕ}_{d , 0} & B {ϕ}_{d , 0}^{′} & C {ϕ}_{d , 0}^{″} \\ ⋮ & ⋮ & ⋮ \\ A {ϕ}_{d , N} & B {ϕ}_{d , N}^{′} & C {ϕ}_{d , N}^{″}\end{matrix} ) \qquad ( 17 )$$

In either formulation, the form of the original ODE is preserved.

However, when taking the tensor product, the result includes unwanted mixed derivative terms and the incorrect ODE coefficients; for example, multiplying two rows on the MPS leg vectors yields

(Aϕ_{0,0}+Bϕ_{0,0}′+Cϕ_{0,0}″)(Aϕ_{1,0}+Bϕ_{1,0}′+Cϕ_{1,0}″)=AAϕ_{0,0}ϕ_{1,0}+ABϕ_{0,0}ϕ_{1,0}′+ (18)

The unwanted mixed derivative terms are considered to be unwanted with respect to the target ODE. As there were no mixed derivative terms, it is desirable to get rid of them. One goal is to obtain correct ODE coefficients, which means recovering the original coefficients.

### 5.0.1 Embedding Coefficients

To embed the correct ODE coefficients, Â (or A_hat) is defined as

$$\hat{A} = \sqrt[D]{A} \qquad ( 19 )$$

which allows for the tensor product of the A coefficients to be correctly recovered as follows:

$$A ϕ ( x ) = {\prod }_{D} \sqrt[D]{A} ϕ ( {x}_{d} ) \qquad ( 20 )$$

In a similar manner, and ignoring any cross terms, one can derive \hat{B} (or B_hat) and C (or C_hat) as follows:

$$\hat{B} = \frac{B}{\sqrt[D - 1]{\hat{A}}} \qquad ( 21 )$$

$$\hat{C} = \frac{C}{\sqrt[D - 1]{\hat{A}}} \qquad ( 22 )$$

When D is even in Equations (19) or (20), and when D is odd in Equations (21) or (22), negative values of A result in complex roots. This can be avoided, for example, by multiplying the ODE by −1 to ensure A is positive.

Alternatively, Â, \hat{B}, and/or Ĉ can be defined or derived using another suitable function. For example, Â=f(A, D), \hat{B}=g(A, B, D), and Ĉ=g(A, C, D).

### 5.0.2 Exotic Algebra for Mixed Term Elimination

The other issue with the naive embedding of the ODE is that under the tensor product, unwanted mixed derivative terms appear in the final equation. To eliminate these terms in the tensor contraction, one can apply an exotic algebra a, b, c with the rules

a*a=1 a*b=1 a*c=1

b*b=0 c*c=0 b*c=0

a²*a=a b²*b=0 c²*c=1

where a², b², c² are defined below.

This algebra can then be applied as coefficients for the RBF derivative terms

$${ϕ}_{d} = ( \begin{matrix}a {ϕ}_{d , 0} & b {ϕ}_{d , 0}^{′} & c {ϕ}_{d , 0}^{″} \\ ⋮ & ⋮ & ⋮ \\ a {ϕ}_{d , N} & b {ϕ}_{d , N}^{′} & c {ϕ}_{d , N}^{″}\end{matrix} ) \qquad ( 23 )$$

where it is apparent that any unwanted mixed terms will now be eliminated by the rules of the exotic algebra. For dimensions where d=0 or D, the coefficients are the square terms, i.e., matrices not vectors. Only on the edges are the coefficients not squared terms as shown in FIG. 5, which shows the necessity of the use of squared exotic coefficients to represent matrices.

The exotic algebra is defined where a, b, c∈ [symbol] ², where

[symbol]

a|=(1 0) (24)

[symbol]

b|=(1 i) (25)

[symbol]

c|=(1 i) (26)

and | [symbol] = [symbol] |^{T}, not the usual conjugate transpose of the bra-ket notation. It can be seen then, for example, that

[symbol]

a*b= [symbol] a|b [symbol] =1·1+0·i=1 (27)

b*b= [symbol] b|b [symbol] =1·1+i·i=1−1=0 (28)

with

a²=|a [symbol] [symbol] a| (29)

### 5.1 Correctly Embedding the ODE

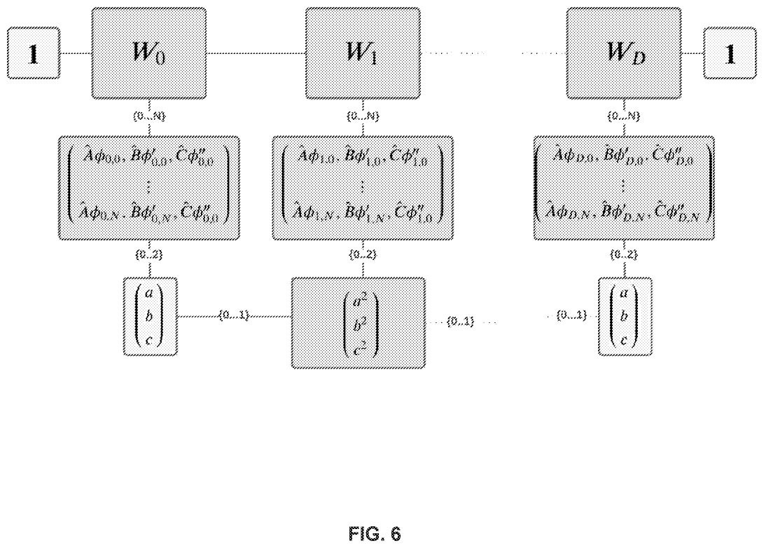

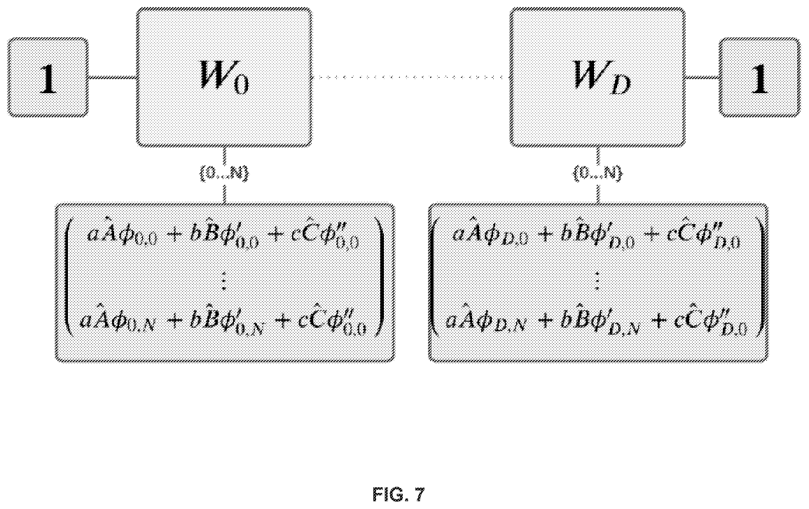

It can now be seen that the correct embedding of the ODE into the RBF vector is given by

$${ϕ}_{d} = ( \begin{matrix}\begin{matrix}a \hat{A} {ϕ}_{d , 0} + b \hat{B} {ϕ}_{d , 0}^{′} + c \hat{C} {ϕ}_{d , 0}^{″} \\ ⋮\end{matrix} \\ a \hat{A} {ϕ}_{d , N} + b \hat{B} {ϕ}_{d , N}^{′} + c \hat{C} {ϕ}_{d , N}^{″}\end{matrix} ) \qquad ( 30 )$$

where the exotic algebra coefficients are assumed to be scalars; one can use customized programming types to create such a system. Inserting this in a tensor diagram, an MPS system for embedding the ODE may be formed as shown in FIGS. 6-7.

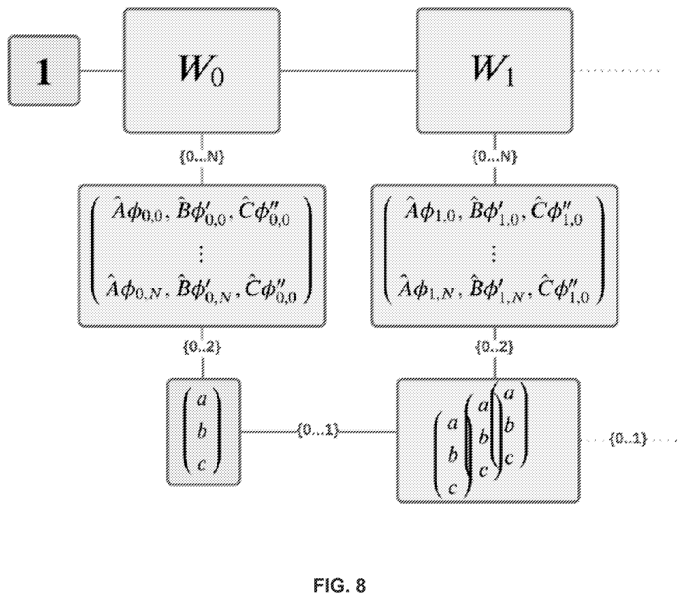

In the light of being more mathematically complete, this can also be written in matrix form as shown in FIG. 8.

However, what can be observed here is that the tensor network now takes on a more similar form to a matrix product operator (MPO) with a lower set of 3-tensor contractions. In the vector scalar form, Equation (30), this may be neatly reduced to an MPS by the customized exotic algebra scalar types when implementing this in a suitable programming language.

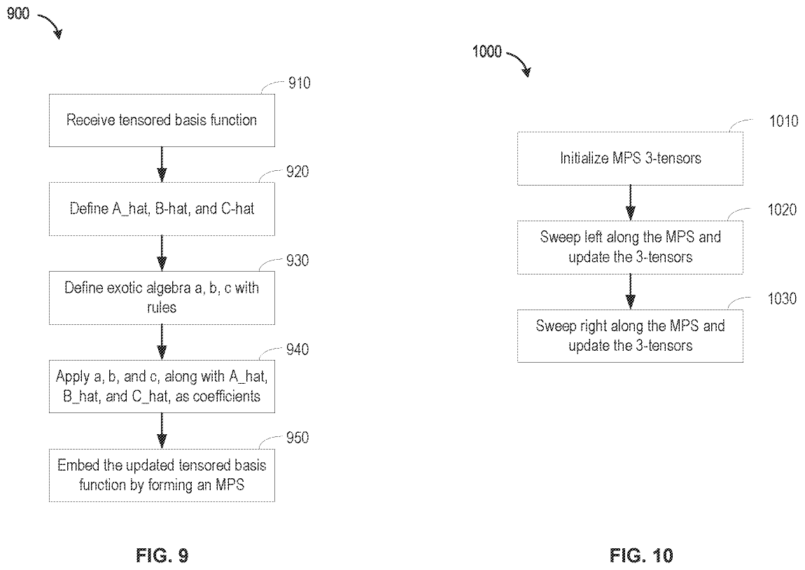

Referring now to FIG. 9, shown therein is a flowchart of an example method 900 for applying tensor radial basis function networks to machine learning by embedding ordinary differential equations (ODEs) into tensor radial basis networks into an MPS. Method 900 may be used by system 100.

At 910, the system 100 receives a tensored basis function having D dimensions and coefficients A_d, B_d, and C_d, where A_d is a zeroth-derivative coefficient for zeroth-derivative terms, B_d is a first-derivative coefficient for first-derivative terms, and C_d is a second-derivative coefficient for second-derivative terms. The tensored basis function may be, for example, defined by a user.

At 920, the system 100 defines A_hat as a function of A (e.g., Dth root of A), B_hat as a function of A and B (e.g., B divided by D−1 root of A), and C_hat as a function of A and C (e.g., C divided by D−1 root of A).

At 930, the system 100 defines an exotic orthogonal algebra a, b, c with vectors consisting of entries with 1, 0 or i, with rules applied thereto, depending on the derivative terms to preserve (e.g., a*a=1, a*b=1, a*c=1, b*b=0, c*c=0, and b*c=0).

At 940, the system 100 applies a, b, and c, along with A_hat, B_hat, and C_hat, as coefficients for the zeroth-derivative, first-derivative, and second-derivative terms, respectively, thereby generating an updated tensored basis function.

At 950, the system 100 embeds the updated tensored basis function by forming a matrix product state (MPS).

### 5.2 Training the MPS

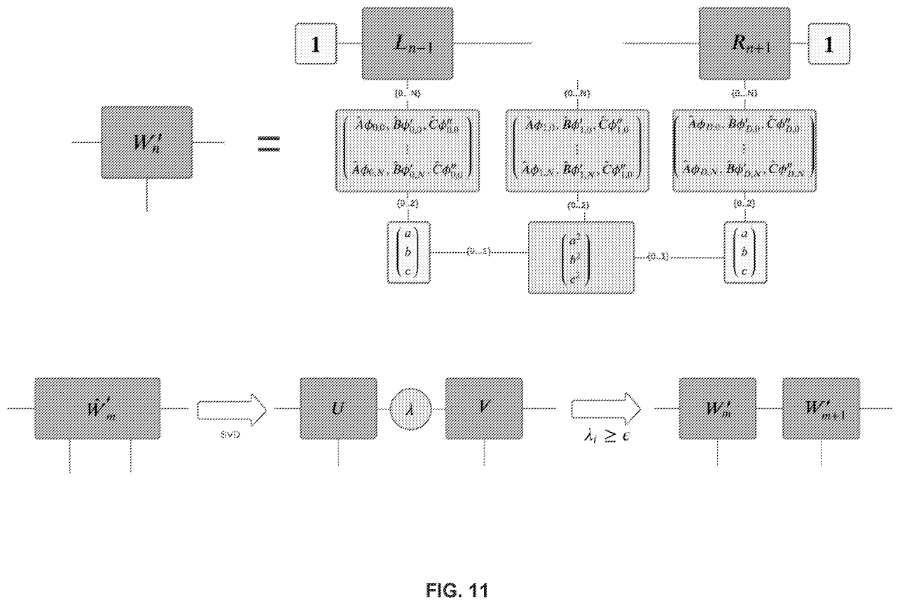

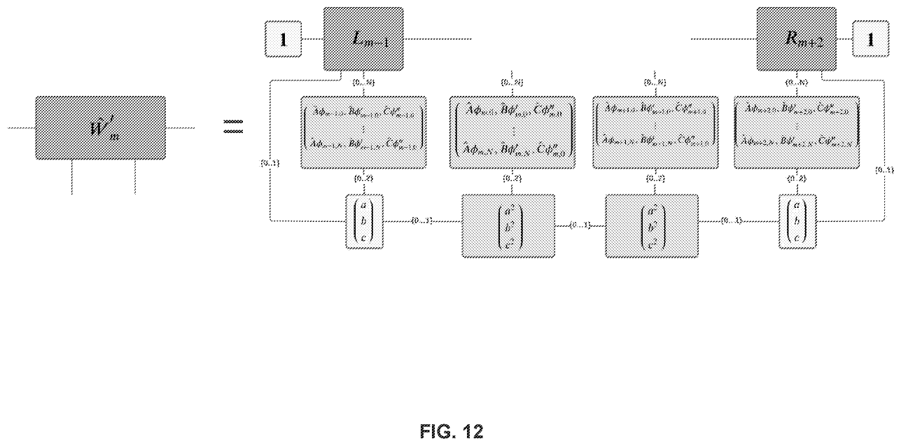

Referring now to FIG. 10, shown therein is a flowchart of an example method 1000 of training an MPS when applying tensor radial basis function networks to machine learning. Method 1000 may be used by system 100 to train the MPS or, in other words, to train the regression, by training the MPS tensor weights. Training the MPS may be done to minimize loss. Training the MPS can be done by choosing an MPS with M+D tensors, where D is the number of dimensions, such that: (1) all tensors except D (with a free index) correspond to one data point i in the batch, and the associated feature vector(s) is [xᵢ, 1−xⱼ] for one dimension, [xᵢ, 1−xᵢ], [yᵢ, 1−yᵢ] for two dimensions, [xᵢ, 1−xᵢ], [y, 1−yᵢ], [zᵢ, 1−zᵢ] for three dimensions, and so on; and (2) D extra tensors in the MPS, such as the central one(s), have a physical dimension of size M, and correspond to the number of possible outputs for a given batch.

The coefficients of the tensors in the MPS can be optimized to minimize the error function, sequentially over all the batches. One epoch of training includes a sweep over all batches. This strategy may dramatically reduce the number of parameters in the fitted function (e.g., with respect to neural networks of TN-Neural Networks) and also converges faster in terms of the number of epochs.

The optimization scheme of the MPS tensors can be a DMRG algorithm. Alternatively, standard auto-differentiation and back-propagation in ML, with the loss function being log-cosh loss, gradient descent, variational optimization, and tangent-space variational methods may be used.

In this application, it is useful to apply the normalization constraint

$${\sum }_{\{ {i}_{0} , … , {i}_{D} \}} {w}_{{i}_{0} , … , {i}_{D}} = 1 \qquad ( 31 )$$

The MPS can typically be trained with either one-site gradient descent rules, wherein the tensors are updated one at a time or two-site gradient descent rules wherein neighboring tensors are updated in pairs. For example, the one-site gradient descent algorithm for updating a tensor for sweep Aₙ(t) is as follows:

$${A}_{n} ( t + 1 ) = {A}_{n} ( t ) + \frac{\partial \hat{Φ} W}{\partial {A}_{1}} \qquad ( 32 )$$

where

$$\frac{\partial \hat{Φ} W}{\partial {A}_{1}}$$

is given by the MPS contraction with the Aₙ tensor removed.

At 1010, the system 100 initializes MPS 3-tensors with random coefficients.

At 1020, the system 100 sweeps left along the MPS and updates the 3-tensors. For example, the tensors may be updated by any known method for updating tensors, including, but not limited to, a density matrix renormalization group (DMRG) algorithm, gradient descent and variational optimization, tangent-space variational methods, standard auto-differentiation and back-propagation, as described above.

In embodiments where the MPS is trained with two-site gradient descent rules, the tensor weights can be updated in a pairwise fashion. For example, a pair of weight tensors with index m and m+1 may be updated simultaneously.

As shown in FIG. 11, to update the tensor weights, the combined derivative of the pair may be calculated. The derivative may be calculated from the tensor network by removing the pair of weight tensors from the tensor network and contracting the remaining tensor network. In FIG. 11, L corresponds to a left-environment tensor, corresponding to the contracted tensor network to the left of the pair m, m+1, and R corresponds to the right-environment tensor, corresponding to the contracted tensor network to the right of the pair m, m+1. The combined derivative obtained may be split, for example, using singular value decomposition (SVD). For a given threshold on the singular values, singular values and their corresponding components may be stored in the U and V tensors to obtain a truncated SVD.

The singular values of the truncated SVD may then be contracted into the U and V tensors, and the truncated SVD U and V tensors may be used as updated derivative weight tensors for each of the weight tensors in the pair.

The derivative weight tensors may be added to the original tensors in the pair that is being updated using, for example, standard gradient update rules.

This process may be repeated until the entire MPS is swept, that is, before each iteration, m is incremented until all tensor pairs have been considered.

At 1030, the system 100 sweeps right along the MPS and updates the 3-tensors, for example, as at 1020. Similar to 1020, the tensor weights may be updated in a pairwise fashion.

The sweeping left and right and updating process may be repeated until a convergence criterion is met.

The pseudocode below shows an example embodiment of method 1000, where domain points are provided along each dimension, all the RBF entries are precomputed for each domain point in each dimension independently, and the tensor product constructs both the domain grid-point and the full RBF. This technique requires storing the matrix of domain RBF entries for each dimension but has the advantage of reducing computational overhead.

```
Inputs:
  X: Problem domain. X is a set of D vectors for each dimension's
grid points.
  R: RBF domain. R is the set of D vectors for each dimensions
RBF centers.
  χ: Bond dimension. Integer value for MPS bond dimensions.
mps = new_mps(χ) # initialize a new empty mps to build
# Compute the adjusted ODE coefficients with exotic terms a, b,
c.
For each d:
adjusted_coefs[d] = calculate adjusted coef(A_d, B_d, C_d ... . . )
# -> [aA_hat, bB_hat, cC_hat]
End For
# Construct the leg tensors
For each d:
ode_d = new_matrix(size(rd), size(xd) )
    For xd_i in xd in X:
      For rd_j in rd in R:
phi_ij = phi(rd_j, xd_i)
ode_d[i, j] = dot_product( [phi_ij, phi_ij. first_derivative, .
. ], adjusted_coefs[d] ]
mps.add_leg(ode_d) # Add the d-dimension leg to the MPS
      End For
    End For
End For
mps.random_initialise( )
F(X) = ode_rhs (X) # calculate the right hand side of the equation
for all domain grid points
While   not   stopping  criteria:
  Y = mps.contract ( ) # Contract MPS to get Y vector of outputs
  loss = rmse(Y, F(X) ) # root mean square error
  mps.update(loss) # performs the weight learning update
```

The pseudocode below shows another example embodiment of the method 1000, where MPS leg vectors are computed at runtime during each iteration. In this embodiment, all the domain mesh points are explicitly provided. The use of mesh points provides added flexibility, as the domain is not tensorized, allowing any random set of points in the domain to be used. Each mesh point is then evaluated in the training loop. When compared to the first embodiment, this embodiment is more computationally expensive but requires less memory overhead as values need not be precomputed.

```
Inputs:
  X: Problem grid points. X is a list of d-dimensional vectors
representing each mesh point.
  R: RBF domain. R is the set of D vectors for each dimensions
RBF centers.
  χ: Bond dimension. Integer value for MPS bond dimensions.
mps = new_mps(χ) # initialize a new empty mps to build
# Compute the adjusted ODE coefficients with exotic terms a, b,
c.
For each d:
adjusted_coefs[d] = calculate_adjusted_coef(A_d, B_d, C_d ... . . )
# -> [aA_hat, bB_hat, cC_hat]
End For
# Construct the leg tensors
For each d:
ode_d = new_matrix(size(rd), size(xd) )
    For xd_i in xd in X:
      For rd_j in rd in R:
phi_ij = phi(rd_j, zd_i)
ode_d[i, j] = dot_product ([phi_ij, phi_ij.first_derivative, .
. ], adjusted_coefs[d] ]
      End For
    End For
mps.add_leg (ode_d) # Add the d-dimension leg to the MPS
End For
mps.random_initialise( )
F(X) = ode_rhs(X) # calculate the right hand side of the equation
for all domain grid points
While not stopping criteria:
For x_i in X:
    For x_id in x:
      For rd_j in rd in R:
phi_dj = phi(rd_j, x_id)
ode_d[j] = dot_product( [phi_dj, phi_dj.first_derivative, . . ],
adjusted_coefs[d] ]
      End For
mps.set_leg (d, ode_d) # Add the d-dimension leg to the MPS
    End For
  Y_i = mps.contract( ) # Contract MPS to get Y vector of outputs
  loss += (Y_i − F(x_i) ) **2 # update loss with loss value
End For
mps.update(loss) # performs the weight learning update
```

It will be understood that the two embodiments described above are example embodiments, and other combinations of precomputing and computing elements at runtime may be used, depending on memory overheads.

For larger systems, one can use two-site updates, where pairs of tensors Aₙ, Aₙ₊₁ are updated together similar to the above described one-site rule but with the additional step of applying singular-value decomposition and rank truncation to result in also learning the shape of the tensors.

### 6. Enhancing Parallelism

When training the MPS for solving ODEs, the process naturally lends itself to high degrees of parallelism for the sets of tensor contractions in the MPS. One can obtain a D degree of parallelism by contracting each 3-tensor weight with its leg 1-tensor independently. Furthermore, logarithmic parallelism can then be obtained during the MPS sweeps by contracting a sequence of adjacent pairs of tensors.

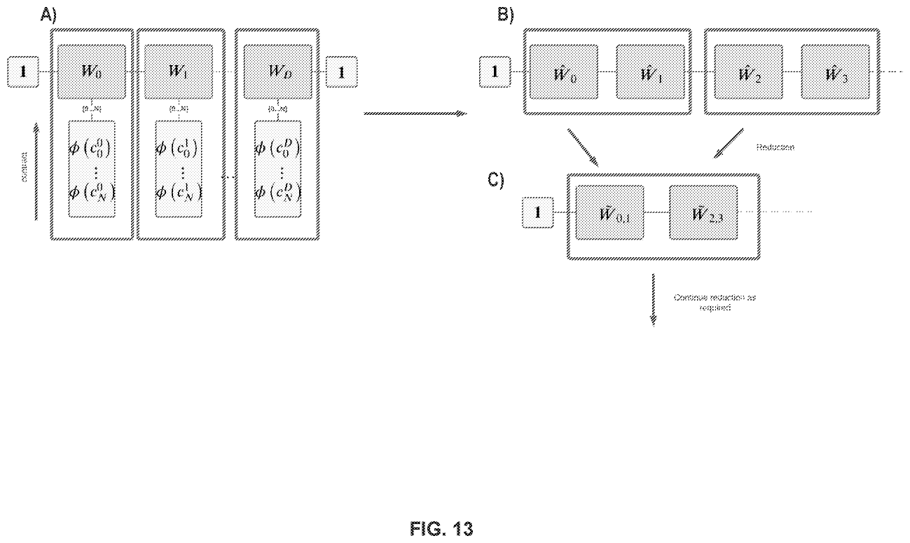

For example, as shown in FIG. 13 at step A), the legs are contracted into the weight tensors. As shown at step B), when the system 100 sweeps left or right along the MPS to update a given tensor, pairs of adjacent tensors can be contracted. The contraction process at step B) may be repeated on previously contracted pairs using a standard parallel reduction algorithm as is known to those skilled in the art.

### 7. Two-Dimensional Example

For a two-dimensional ODE, equations 1-3 may be expressed as

$$[ {C}_{0} \frac{{\partial }^{2}}{\partial {x}_{0}^{2}} + {C}_{1} \frac{{\partial }^{2}}{\partial {x}_{1}^{2}} + {B}_{0} \frac{\partial }{\partial {x}_{0}} + {B}_{1} \frac{\partial }{\partial {x}_{1}} + {A}_{0} ] u ( x ) = 0 \qquad ( 33 )$$

and the adjusted ODE coefficients may be

$$\hat{A} = \sqrt{A} , {\hat{C}}_{0} = \frac{{C}_{0}}{\hat{A}} , {\hat{C}}_{1} = \frac{{C}_{1}}{\hat{A}} , {\hat{B}}_{0} = \frac{{B}_{0}}{\hat{A}} , {\hat{B}}_{1} = \frac{{B}_{0}}{\hat{A}}$$

The center points along each dimension of the ODE domain may then be defined. For a two-dimensional example with 4 RBFs in each dimension, with a square domain with grid points (x₀, x₁)ϵ[0.25, 0.5, 0.75, 1]×[0.25, 0.5, 0.75, 1], where x is the cross product, the RBF centers can be located at the same grid points.

The leg vectors for each of the RBF centers in each dimension can then be calculated by multiplying each term by the associated adjusted ODE coefficient and the exotic algebraic term.

In this example, for the first RBF with center in the first dimension r₀=0.25 x₀=0.25,

[symbol]

\hat{ϕ}_{0,0,0}(0.25,0.25)=aÂϕ(0.25,0.25)+b [symbol] ϕ′(0.25,0.25)+cĈ₀ϕ″(0.25,0.25)

Similarly, for the second RBF in the first dimension with center r₁=0.5 x₀=0.25,

\hat{ϕ}_{0,1,0}(0.25,0.25)=aÂϕ(0.5,0.25)+b [symbol] ϕ′(0.5,0.25)+cĈ₀ϕ″(0.5,0.25)

and for the first RBF in the second dimension r₁=0.25 x₁=0.25,

\hat{ϕ}_{1,0,0}(0.25)=aÂϕ(0.25,0.25)+b [symbol] ϕ′(0.25,0.25)+cĈ₀ϕ″(0.25,0.25)

As described above, the weight tensors can then be initialized with initial entries, which may be randomly sampled. The system 100 then iterates over each data point contracting the tensor network to calculate an output. The loss function is then calculated based on the output and the weights in the weight tensors updated using an optimization procedure. This process can be repeated until a stopping criterion is met.

One technical advantage realized in at least one of the embodiments described herein is exponential memory savings for high-dimensional meshes using an exponentially scaling number of basis functions. For example, conventional systems typically require an exponentially increasing number of basis functions in an exponentially sized grid, when a new dimension is added to the mesh points.

While the applicants teachings described herein are in conjunction with various embodiments for illustrative purposes, it is not intended that the applicants teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for embedding ordinary differential equations into tensor radial basis networks comprising at least one processor configured to:
receive a tensored basis function having D dimensions and coefficients A_d, B_d, and C_d, where A_d is a zeroth-derivative coefficient for zeroth-derivative terms, B_d is a first-derivative coefficient for first-derivative terms, and C_d is a second-derivative coefficient for second-derivative terms;
define A_hat as a function of A and D, B_hat as a function of A, B, and D, and C_hat as function of A, C, and D;
define an orthogonal exotic algebra a, b, c;
apply a, b, and c, along with A_hat, B_hat, and C_hat, as coefficients for the zeroth-derivative, first-derivative, and second-derivative terms, respectively, thereby generating an updated tensored basis function; and
embed the updated tensored basis function by forming a matrix product state (MPS) and training the MPS.

2. The system of claim 1, wherein the MPS comprises MPS 3-tensors, and training the MPS comprises:
initializing the MPS 3-tensors with random coefficients;
sweeping left along the MPS and updating the MPS 3-tensors; and
sweeping right along the MPS and updating the MPS 3-tensors.

3. The system of claim 1, wherein the at least one processor is configured to embed the tensored basis function as a matrix of scalar coefficients.

4. The system of claim 3, wherein the at least one processor is configured to embed the tensored basis function as products of A_hat, B_hat C_hat, corresponding a, b, c, coefficients, and corresponding tensored basis function derivative terms.

5. The system of claim 1, wherein the exotic orthogonal algebra has a*a=1, a*b=1, a*c=1, b*b=0, c*c=0, and b*c=0.

6. The system of claim 1, wherein updating the MPS 3-tensors comprises updating the MPS 3-tensors with gradient descent rules.

7. The system of claim 1, wherein the MPS is further trained by:
contracting each 3-tensor coefficient with a corresponding leg 1-tensor.

8. The system of claim 1, wherein the MPS is further trained by:
contracting pairs of adjacent 3-tensors.

9. The system of claim 1, wherein updating the MPS 3-tensors comprises updating the MPS 3-tensors pairwise.

10. The system of claim 1, wherein the MPS is trained until a convergence criterion is satisfied.

11. A method of embedding ordinary differential equations (ODEs) into tensor radial basis networks comprising:
receiving a tensored basis function having D dimensions and coefficients A_d, B_d, and C_d, where A_d is a zeroth-derivative coefficient for zeroth-derivative terms, B_d is a first-derivative coefficient for first-derivative terms, and C_d is a second-derivative coefficient for second-derivative terms;
defining A_hat as a function of A and D, B_hat as a function of A, B, and D, and C_hat as function of A, C, and D;
defining an exotic orthogonal algebra a, b, c;
applying a, b, and c, along with A_hat, B_hat, and C_hat, as coefficients for the zeroth-derivative, first-derivative, and second-derivative terms, respectively, thereby generating an updated tensored basis function; and
embedding the updated tensored basis function by forming a matrix product state (MPS) and training the MPS.

12. The method of claim 11, wherein the MPS comprises MPS 3-tensors, and training the MPS comprises:
initializing the MPS 3-tensors with random coefficients;
sweeping left along the MPS and updating the MPS 3-tensors; and
sweeping right along the MPS and updating the MPS 3-tensors.

13. The method of claim 11, wherein the tensored basis function is embedded as a matrix of scalar coefficients.

14. The method of claim 13, wherein the tensor basis function is embedded as products of A_hat, B_hat C_hat, corresponding a, b, c, coefficients, and corresponding tensored basis function derivative terms.

15. The method of claim 11, wherein the exotic orthogonal algebra a, b, c, has rules a*a=1, a*b=1, a*c=1, b*b=0, c*c=0, and b*c=0.

16. The method of claim 11, wherein updating the MPS 3-tensors comprises updating the MPS 3-tensors with gradient descent rules.

17. The method of claim 11, wherein the MPS is further trained by:
contracting each 3-tensor coefficient with a corresponding leg 1-tensor.

18. The method of claim 11, wherein the MPS is further trained by:
contracting pairs of adjacent 3-tensors.

19. The method of claim 11, wherein updating the MPS 3-tensors comprises updating the MPS 3-tensors pairwise.

20. The method of claim 11, wherein the MPS is trained until a convergence criterion is satisfied.
